(19) United States
(12) Patent Application Publication
(10) Pub. No.: US 2005/0105472 A1
(43) Pub. Date: May 19, 2005

(54) Test access matrix (TAM) protector module and associated circuitry for a telecommunications system

(76) Inventors: Alan J. Squillante, Kings Oark, NY (US); Clifford D. LeStrange, Stony Brook, NY (US); Peter Kobsa, Floral Park, NY (US)

Correspondence Address: Gerald T. Bodner;Bodner & O'Rourke, LLP, 425 Broadhollow Road, Suite 108, Melville, NY, 11747, US

(21) Appl. No.: 10/987,898

(22) Filed: Nov. 12, 2004

Related U.S. Application Data
(60) Provisional application No. 60/520,053, filed on Nov. 14, 2003.

(51) Int. Cl. H04J 1/16; H04J 3/14

(52) U.S. Cl. 370/247

(57) ABSTRACT

A Test Access Matrix (TAM) system permits installation onto an existing connector block. The TAM system exhibits a configuration that permits installation on to telecommunications circuits at the connection point provided for installation of protection modules or other devices that are inserted into the telecommunications circuit. The installation can be accomplished either before new or after existing connector blocks are installed on a telecommunication cross connect frame, tie frame, or other support structure. The TAM system can be instructed to connect a two or four wire test bus to any of the individual telecommunications circuits that are connected to the connector block. The test bus can be connected to the individual communication circuits in either a bridging, break towards the distribution side of the local loop, break towards the telecommunications equipment, or an insertion into the line via a “make before break” sequence. The bus can be further redirected to multiple test or monitoring devices.

### CROSS-REFERENCE TO RELATED APPLICATIONS

This application is related to U.S. Provisional Application Ser. No. 60/520,053, filed on Nov. 14, 2003, and entitled “Test Access Matrix (TAM) Protector Module and Associated Circuitry for a Telecommunications System”, the disclosure of which is incorporated herein by reference and on which priority is hereby claimed.

### BACKGROUND AND OBJECTS OF THE INVENTION

The nature of Plain Old Telephone Systems (POTS) equipment in the telecommunications industry is such that a test facility can locate faults in the local loop through the Central Office (CO) equipment. Test facilities to locate faults in the local loop that affect high data rate systems such as DSL typically need to be located between the CO equipment and the local loop. The test facility is switched into the line that needs to be tested using what is known as a Test Access Matrix (TAM). The TAM typically switches one of a plurality of two wire telecommunications circuits to a two or four wire test bus.

Connector blocks are typically installed on Main Distribution Frames (MDF) in the CO between the CO equipment and the local loop. Some connector blocks include contacts for mounting protector modules, which are electrically connected to the contacts. A TAM module in accordance with the present invention that can be plugged into the contacts on existing blocks on the MDF offers a substantial benefit over a conventional TAM that replaces an existing block. Installation cost and system downtime due to installing a plug in TAM is reduced when compared to a unit that must be installed by cutting into the existing infrastructure or removing existing hardware that was permanently installed and permanently installing new hardware.

Other such plug in devices have been proposed, but no such device seen to date is robust and compact enough to be considered adequately reliable. This invention provides a means to provide the required functionality and reliability for an acceptable cost to install. This solution offers the additional advantage of having single twisted pair count TAM modules. In the rare event that a module fails, adjacent circuits are not affected. Multiple low twisted pair count magazines (integrating several single pair count TAM modules) can also be used, affording a small installation savings but negatively impacting life cycle cost.

### SUMMARY OF THE INVENTION

The present invention is a TAM system that is installed on a single pin, five-pin or other type of telephone protector/connector block. The TAM system includes a plurality of TAM modules, a motherboard with a preferably integral control matrix and a controller that are preferably installed on a connector block. The TAM modules have integrated relays and surge protection devices. Additional connections are required to interface with the motherboard rather than the standard 5 connections used in typical single circuit protector modules. The motherboard is installed between the protector modules and the connection field of the block. A controller can be integrated into the motherboard, installed onto the block, or remotely located. The control function is designed to facilitate the connection of multiple blocks to each other for control purposes using a low wire count bus.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram of the overall Test Access Matrix (TAM) system of the present invention.

FIG. 2 is a detailed schematic diagram of the preferred circuit of a TAM module of the present invention, forming part of the system shown in FIG. 1.

FIG. 3A is a detailed schematic diagram of a portion of the TAM module circuit shown in FIG. 2 in a first test mode.

FIG. 3B is a detailed schematic diagram of a portion of the TAM module circuit shown in FIG. 2 in a second test mode.

FIG. 3C is a detailed schematic diagram of a portion of the TAM module circuit shown in FIG. 2 in a third test mode.

FIG. 3D is a detailed schematic diagram of a portion of the TAM module circuit shown in FIG. 2 in a fourth test mode.

FIG. 4 is a schematic diagram of the circuit of the motherboard control matrix of the present invention, forming part of the TAM system shown in FIG. 1.

FIG. 5 is an exploded isometric view of selected TAM system components of the present invention mounted on a standard single pin connector block.

FIG. 6 is an exploded isometric view of selected TAM system components of the present invention mounted on a standard five pin connector block.

FIG. 7A is a detailed schematic diagram of a portion of the TAM module circuit having two relays to interface with a two wire test bus and shown in a normal mode of operation (i.e., non-test mode).

FIG. 7B is a detailed schematic diagram of the two relay TAM module shown in FIG. 7A in a first test mode.

FIG. 7C is a detailed schematic diagram of the two relay TAM module shown in FIG. 7A in a second test mode.

FIG. 7D is a detailed schematic diagram of the two relay TAM module shown in FIG. 7A in a third test mode.

### DETAILED DESCRIPTION OF THE PREFERRED EMBODIMENTS

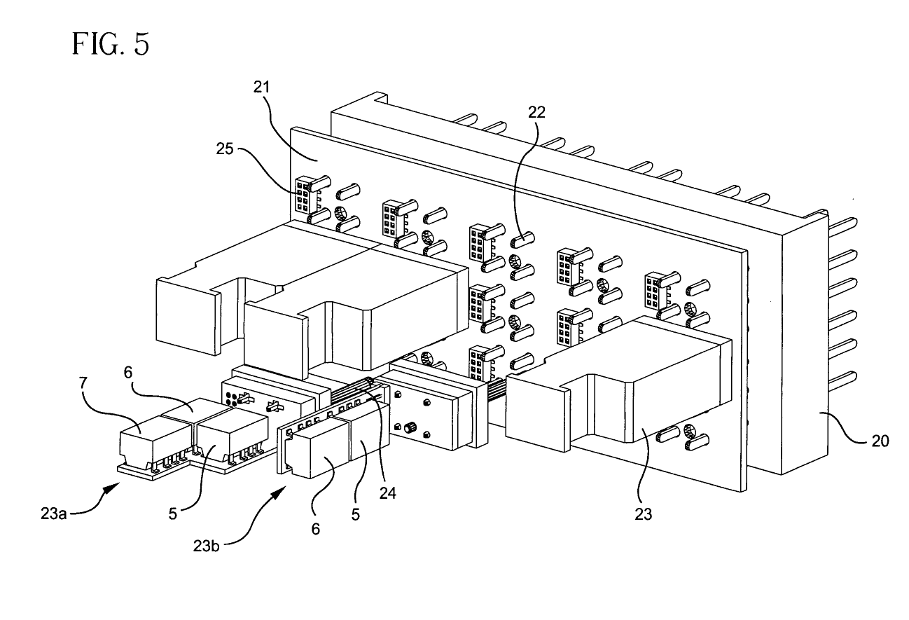

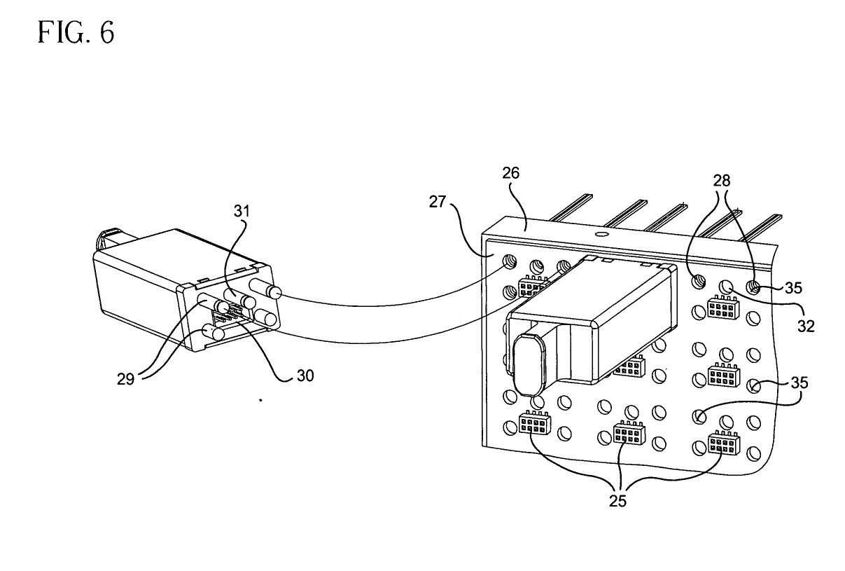

In accordance with one form of the present invention, a Test Access Matrix (TAM) system includes a plurality of protected TAM modules 1 (1) through (n). The modules 1 are connected to a motherboard (e.g., a printed circuit board) (2) which as is illustrated by FIGS. 5 and 6 is mountable to one side of a connector block, as will be described in greater detail. The TAM system of the present invention also includes a control matrix (3) and a controller (4), for example, a circuit, which receives a control signal from the Central Office (CO) to initiate, for example, a test of the CO equipment or the local loop (also referred to herein as the distribution equipment). The controller (4) and the control matrix (3) each may be situated on the motherboard (2) of the TAM system, or may be remotely situated with respect to the motherboard (2).

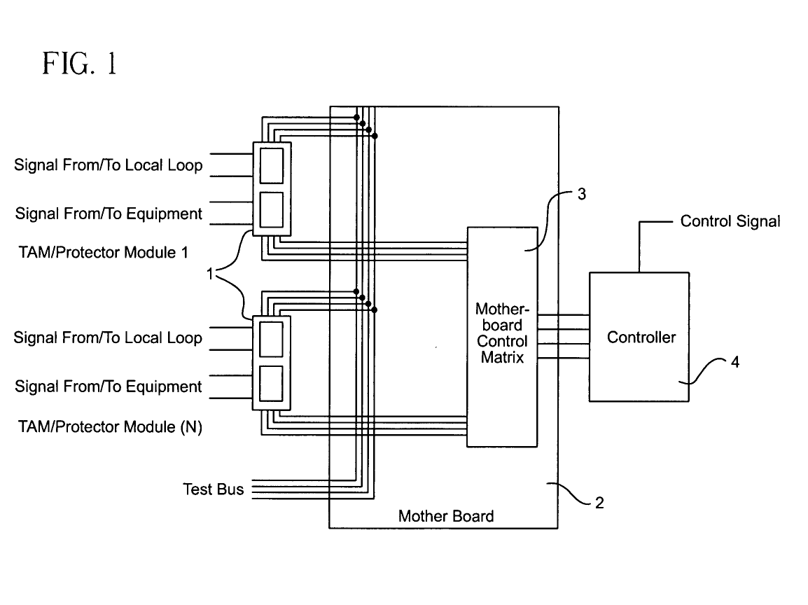

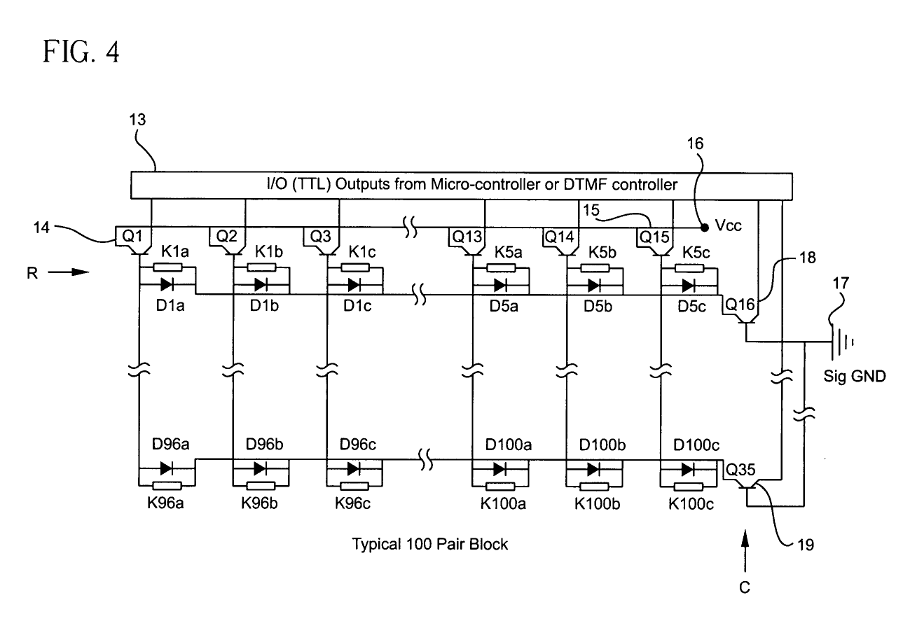

As shown in FIG. 1, the controller (4) receives control signals from the CO, as mentioned previously, which control signals contain information designating what telephone circuit should be tested and the kind of test which is to be performed. The controller (4) may be a demultiplexer circuit or a programmable read only memory (PROM), or a random access memory (RAM), or even more preferably, a microcontroller or a dual tone multi-frequency (DTMF) controller having preferably I/O (input/output) TTL (Transistor Transistor Logic) outputs, such as shown in FIG. 4 of the drawings, or any other type of controller circuit known to those skilled in the art. The controller (4) provides signals on a single wire or a bus to the control matrix (3) which, in turn, provides signals to the selected TAM modules (1) in order to test a particular telephone circuit, either on the distribution side or the equipment side, or both, and to select the particular test which is to be performed.

As can be seen from FIG. 1 of the drawings, each protected TAM module (1) is connected to a particular telephone circuit and passes through it signals from and to the local loop (i.e., the distribution side) and signals from and to the CO (i.e., the equipment side). When a particular telephone circuit is selected for testing, the control matrix (3) activates relays or other switching circuits in the corresponding TAM module (1) through (n) associated with that telephone circuit. Each TAM module (1) through (n) is connected to a test bus, and the particular TAM module having relays or switching circuits that are activated by the control matrix (3) provides on the test bus test signals that represent and from which may be determined the condition of the telephone lines associated therewith, that is, the lines from the CO or the local loop, or both. The test bus is provided to the CO which may then determine from the signals carried on the test bus if there is a problem with the lines, the kind of problem (for example, a short or open circuit), and on which side (i.e., the equipment side or the distribution side) the problem occurs.

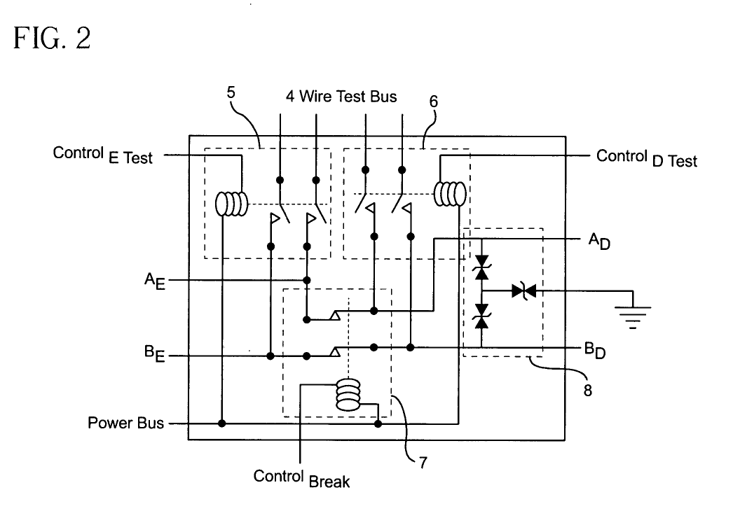

The preferred circuit of the TAM module (1) is shown in FIG. 2 of the drawings. The TAM module preferably includes three relays (5)-(7) and a protector circuit (8). Although relays (5)-(7) are shown, it is of course envisioned to be within the scope of the present invention to substitute for the relays solid state circuits that perform the same function as the relays.

The relays (5)-(7) are shown in FIG. 2 as being double pole, single throw relays. Double pole, double throw relays, single pole, double throw relays and single pole, single throw relays may also be used. The protector circuit (8) which is shown in FIG. 2 is a partially balanced solid state overvoltage surge suppressor, as is well known in the art, and includes three thyristors, two of which are connected in series between the two distribution outputs of the module, referenced in FIG. 2 by the notation A_{D} and B_{D}, which are often referred to as the tip and ring lines, and the other thyristor is connected between the series juncture of the first two thyristors and the ground connection. Of course, any overvoltage/overcurrent protector circuit (8) or components known in the art may be employed, as the user requires.

Referring again to FIG. 2 of the drawings, two separate contacts of each of the first two relays (5) and (6) are connected to the wires of a four wire test bus which is connected to other TAM modules and which is routed to the CO so that the signals provided by the activated relays may be evaluated by the CO. The first relay (5) has one end of its coil connected to a control line, referred to in FIG. 2 as the Control_{E test}, and similarly, the second relay (6) has one end of its coil connected to a Control_{D test}. The other ends of the coils of the first and second relays (5) and (6) are provided to a power bus.

The third relay (7) of the preferred TAM module (1) has one end of its coil connected to another line referred to in FIG. 2 as a Control_{Break}, and the other end of its coil connected to the power bus referred to previously. Accordingly, energization of one or more of the Control_{E test}, Control_{D test}, Control_{Break} and the power bus lines will activate one or more of the three relays (5)-(7).

The equipment circuit telephone lines are provided to the TAM module (1) and are referred to in FIG. 2 by the notation A_{E} and B_{E}. The two equipment lines are connected to two contacts of the third relay (7) and the other two contacts of the first relay (5). The other corresponding contacts of the third relay (7) are connected to the other contacts of the second relay (6) and to the protection circuit (8) and the output pins or sockets connectable to the distribution lines, referred to in FIG. 2 as A_{D} and B_{D}.

The TAM module (1) is shown in FIG. 2 in its normal, non-test mode. The third relay (7) is energized so that the equipment signals on lines A_{E} and B_{E} pass through the contacts of the relay respectively to distribution lines A_{D} and B_{D}, which are protected by the protector circuit (8). The first relay (5) and the second relay (6) are not activated and, therefore, neither the equipment lines A_{E} and B_{E} nor the distribution lines A_{D} and B_{D} are connected to the four wire test bus.

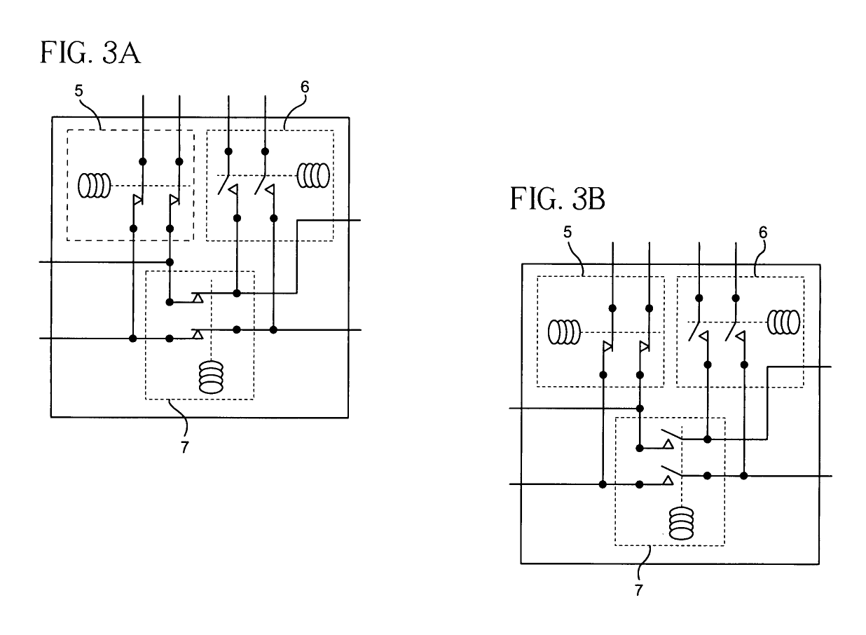

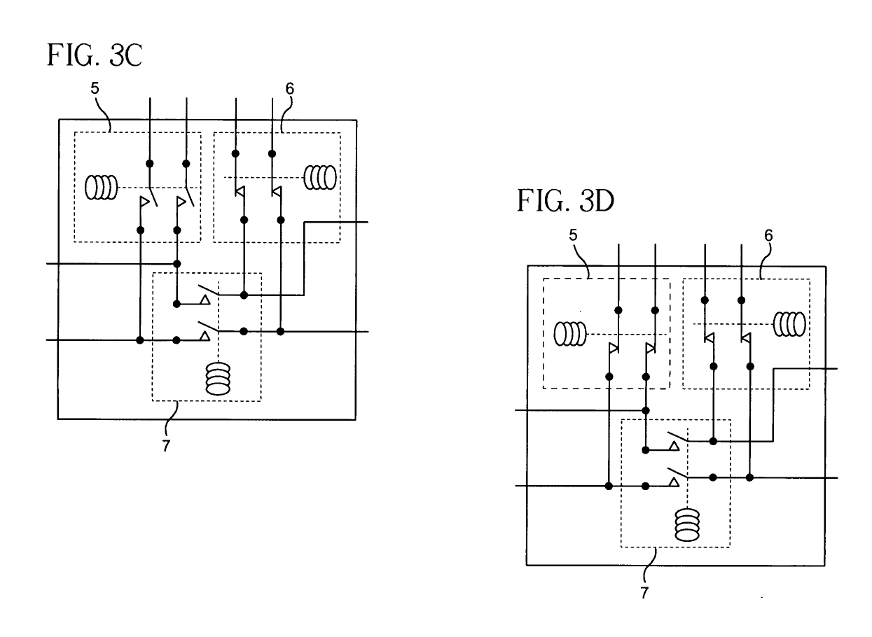

FIGS. 3A through 3D show the activated states of the relays in the TAM protector module (1) in four different test modes. The activated states of the relays (5)-(7) can be configured to perform testing as required, including the monitor or sniff mode, as shown in FIG. 3A; the break toward equipment mode, as shown in FIG. 3B; the break toward distribution mode, as shown in FIG. 3C; and the make before break split mode, as shown in FIG. 3D.

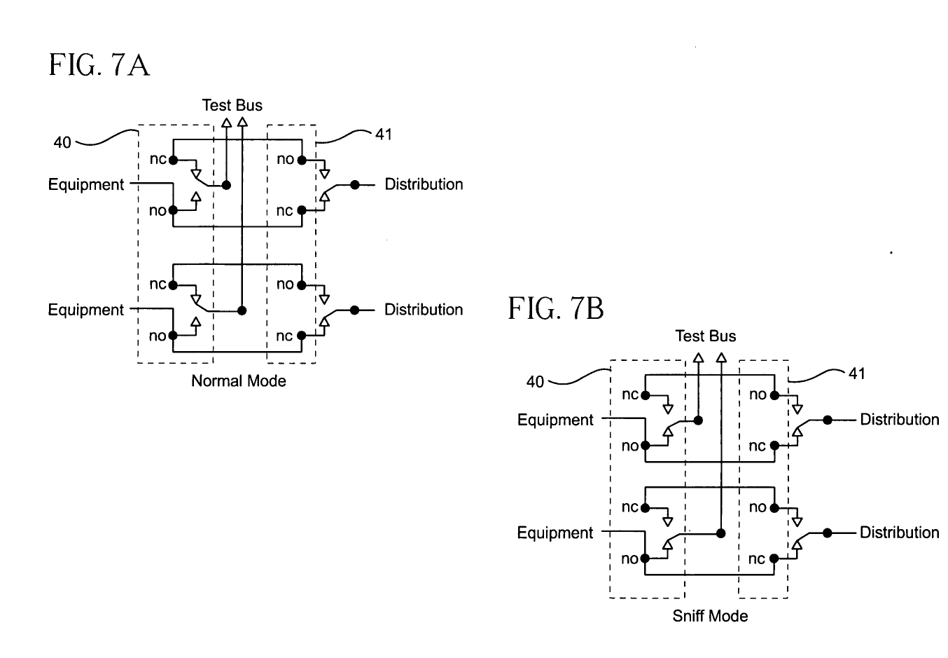

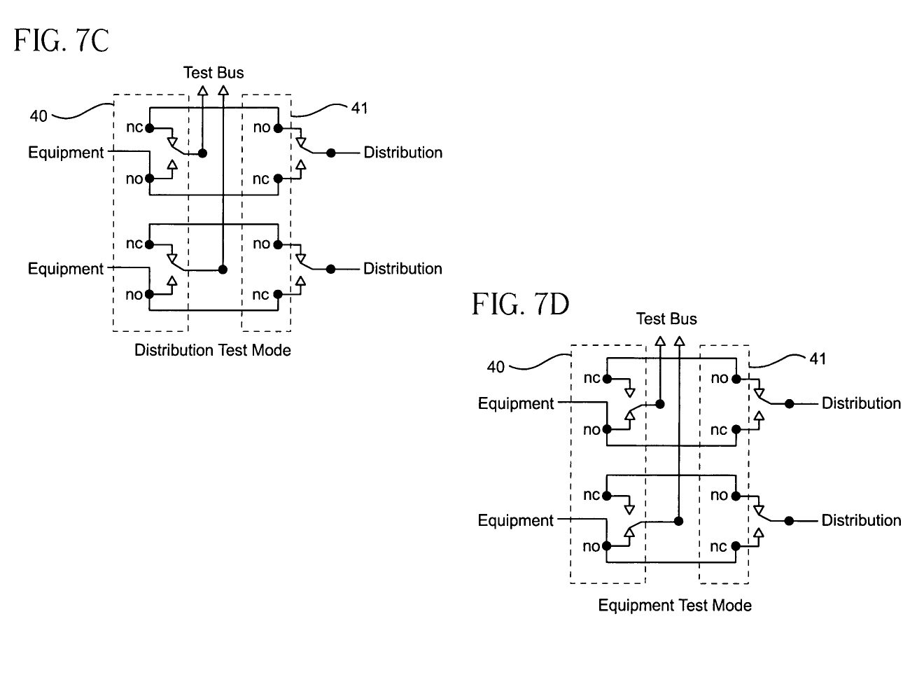

More specifically, in the monitor or sniff mode (FIG. 7A), relays (5) and (7) are activated to close its contacts while relay (6) is not activated and its contacts remain open so that the equipment lines are connected to the distribution or local loop while the lines are being monitored on two wires of the preferably four wire test bus.

In the break toward equipment mode (FIG. 7B), relay (7) deactivates to open its contacts, so that the signal from the equipment does not pass through the TAM module to the distribution lines, and the first relay (5) is activated to close its contacts so that the equipment lines are connected to two wires of the preferably four wire test bus in order to monitor the signal from the Central Office (CO). Relay (6) is deactivated and it contacts remain open.

In the break toward distribution mode (FIG. 7C), again the third relay (7) is deactivated so that its contacts are open, thus breaking the connection between the equipment lines and the distribution lines, and the second relay (6) is activated to close its contacts so that two wires of the preferably four wire test bus are connected to the local loop (distribution lines). In this mode, the first relay (5) is deactivated so that its contacts are open.

In the make before break split mode (FIG. 3D), the third relay (7) is deactivated so that its contacts open, thus breaking the connection between the equipment and the local loop, and the first relay (5) and the second relay (6) are activated to close their respective contacts, so that two wires of the four wire test bus are connected to the equipment lines, and the other two wires of the four wire test bus are connected to the distribution lines.

The control matrix (3), which is preferably situated on the motherboard (2) is shown in FIG. 4 of the drawings. The control matrix (3) is preferably a circuit which employs drive switches, such as transistors, that activate the relays (5)-(7) in the TAM modules (1) through (n). Any number of TTL or microprocessor based control circuits known in the art can be used to perform the control function of the control matrix (3). Because of the need to direct only one circuit passing through a TAM module (1) to the test bus at one time, the control matrix (3) can be used to minimize the connections from the controller (4) to the motherboard (2). The control matrix (3) shown in FIG. 4 is for a 100 wire pair TAM system. Each of the 300 relays shown (K1a through K100c) is in the TAM modules. For example, relays K1a, K1b, and K1c are in TAM module No. 1. Relay Kna is shown by reference number (5) in FIG. 2, relay Knb is shown as reference number (6) in FIG. 2, and relay Knc is designated by reference number (7) in FIG. 2. Protection diodes D1a, D1b, D1c through D100c are connected in parallel with the relay coils of relays K1a, K1b, K1c through K100c with a normally non-conductive polarity to prevent damage to the control matrix (3) due to high voltage spikes caused when the relay coils are switched off, as is well known in the art.

The control circuit (13) of the controller (4) sends signals to the switches of the control matrix (3). In the case of the control matrix (3) shown in FIG. 4, the switches are transistors Q1 through Q35. The control circuit (13) that generates the I/O signals which control the states of switches (transistors) Q1 through Q35 is located in the controller (4). Switches/transistors Q1 through Q35 may be located on the motherboard (2) or in the controller (4). For the 100 wire TAM system, one to three switches (transistors) in each row R of the control matrix (3) (transistor Q1 (14) through transistor Q15 (15) comprise the first row) can be activated to provide relay coil voltage (16), also referred to as Vcc, to a column of modules. Similarly, one switch in the column C of switches (transistor Q16 (18) to transistor Q35 (19) comprise one column) can be activated to provide the signal ground (17) to a row of modules. The relays (5)-(7) in the TAM module (1) at the row R and column C intersection will be activated. The combination and sequence of relays activated will cause the activated TAM module (1)-(n) to allow the test bus to test the chosen circuit in one of the four test configurations shown in FIGS. 3A-3D.

FIG. 5 illustrates the TAM system of the present invention installed on a standard single pin connector block (having one socket for receiving the ground pin of the protector module, and four upstanding pins for the equipment lines and the distribution lines, which are received by sockets in the respective protector or TAM module). The connector block (20) shown has the motherboard (21) on the connection field side of the connector block (20) over the pins (22) in the block for the distribution and equipment line connections. The motherboard (21) preferably does not make electrical contact with the pins (22) on the block. Thus, the motherboard (21) may have pass-through holes formed through the thickness thereof which are aligned with and receive the pins (22) of the connector block (20), the pass-through holes being insulated from the rest of the circuit on the motherboard (21). The equipment and distribution connections within the module (23) make a direct electrical connection to the pins (22) on the connector block (20). The control and test bus connections of the TAM module (23) are made through a connector (30) mounted on the module that connects to a respective connector (25) of a plurality of connectors situated on the motherboard (21). The module ground pin (24) for the protector circuit (8) with the TAM module (23) makes an electrical connection to the connector block ground.

In FIG. 5, three TAM modules (23) are shown, two of which have their housings removed to show the inside of the module. One of the modules (23a) is shown with the first relay (5), the second relay (6) and the third relay (7). The other module (23b) with the housing removed shows an embodiment in which only the first relay (5) or the second relay (6), and the third relay (7), are used in the module. One of the first and second relays (5) and (6) may be omitted, if fewer test modes are desired. It should be noted that with only two relays, additional space is afforded in the TAM module for the circuitry, or the module may be made smaller. It should further be noted that the relays (5)-(7) may be turned on their side within the module to afford additional space, or all three relays (5)-(7) may be arranged in single plane on a printed circuit board within the module.

FIG. 6 illustrates the TAM system of the present invention installed on a standard five pin connector block (26). The connector block (26) shown in FIG. 6 has the motherboard (27) installed on the connection side over the block (26). The distribution and equipment connections on the connector block (26) are the sockets (28). The motherboard (27) preferably does not make electrical contact with the sockets on the block (28) or the distribution and equipment pins and ground pins (29) extending from the TAM module. As in the previous embodiment shown in FIG. 5, the motherboard (27) may include pass-through holes (35) formed through the thickness thereof, which holes (35) receive the distribution and equipment pins (29) and ground pin (31) of the module. The equipment and distribution connection pins (29) protruding from the module (23) make a direct electrical connection to the sockets (28) on the connector block (26) through the pass-through holes (35) of the motherboard (27). The TAM modules (23) in both the embodiment shown in FIG. 5 and the embodiment shown in FIG. 6 include a connector (30) for the control and test bus connections of the module. This connector (30) mates with a cooperating connector (25) of a plurality of cooperating connectors situated on the motherboard (27) and disposed in alignment with the connectors (30) of the TAM modules (23). Thus, the control and test bus connections of the module make a direct connection to the motherboard (27). The module ground pin (31) for the protector circuit makes an electrical connection to the connector block ground socket (32) through a respective pass-through hole (35) of the motherboard (27).

FIGS. 7A through 7D illustrate a TAM module circuit designed in accordance with the present invention to interface with a two wire test bus. Only two relays (40) and (41) are required. The designations “nc” and “no” in FIGS. 7A through 7D respectively refer to the “normally closed” and “normally open” position of the contacts of the relays (40) and (41) for the TAM module circuit interfacing with a two wire test bus. Each respective equipment line is connected to a respective normally open contact of relay (40). The two distribution lines are connected to respective switching contacts of relay (41). The normally closed and normally open contacts of each switching circuit of relay (40) are connected to the normally open and normally closed contacts, respectively, of each corresponding switching circuit of relay (41). The two wire test bus lines are connected to the switching contacts of relay (40).

More specifically, FIG. 7A shows the normal mode of operation for the TAM module circuit for the two wire test bus embodiment. Each equipment line is directly connected to a respective distribution line, and the test bus lines are not connected with either the equipment lines or the distribution lines. Each switching circuit of each of relays (40) and (41) is in its normally closed state so that the equipment lines are electrically connected through relay (41) to the distribution lines.

FIG. 7B shows the TAM module circuit for the two wire test bus in the “sniff” mode. In this mode, each switching circuit of relay (40) is in a normally open state, and each switching circuit of relay (41) is in a normally closed state. The equipment lines are electrically connected to the distribution lines through relay (41), and the test bus lines are connected through relay (40) to the equipment lines.

FIG. 7C shows the TAM module circuit for a two wire test bus in the equipment test mode. Here, the connection between the equipment lines and the distribution lines are broken by relay (41). The equipment lines are connected through relay (40) to the test bus lines. The switching circuits of relay (40) are in their normally open state, and the switching circuits of relay (41) are in their normally open state.

FIG. 7D illustrates the TAM module circuit for the two wire test bus in a distribution test mode. The connection between the equipment lines and the distribution lines are broken through the respective switching circuits of relay (41), but each test bus line is connected to a respective distribution line through the switching circuits of relays (40) and (41). The switching circuits of relay (40) are in their normally closed state, and the switching circuits of relay (41) are in their normally open state.

As can be seen from FIGS. 5 and 6 of the drawings, the TAM system of the present invention adds only the thickness of the motherboard (21) and (27) and its components to the existing space allocated for the connector block, and it is mateable with a conventional connector block. The conventional protection modules are removed from the connector block, and the motherboard (21) and (27) is fitted thereon, as shown in FIGS. 5 and 6. The TAM protector modules (23) of the present invention replace the conventional protector modules and mate with the pins or sockets of the connector block in the same manner as the conventional protector modules mated with the connector block. Thus, no TAM circuit that replaces an existing connector block need be installed by cutting into the existing infrastructure or removing existing, permanently installed hardware. Even in the rare event that one TAM module fails, adjacent circuits are not affected. Furthermore, although individual modules are shown in FIGS. 5 and 6, it is envisioned to be within the scope of the present invention to have magazines comprising a plurality of modules that mate with the equipment or distribution connections of the connector block partially or entirely across a row or column of connections in the connector block. Furthermore, where no protection is required, a TAM module with relays (5)-(7) and no protection circuit (8) can be used to reduce costs.

Additionally, protector modules having a protection circuit (8) only, with no relays (5)-(7), may be used when neither a two wire nor a four wire test bus is required.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

1. A Test Access Matrix (TAM) system operable with a connector block of a telecommunications system for testing telecommunications lines connected to the connector block, which comprises:
a motherboard mountable on the connector block, the motherboard having at least one first connector mounted thereon and a test bus electrically connected to the at least one first connector;
at least one TAM module having an electrical circuit, the at least one TAM module having a second connector mounted thereon which is electrically connectable to the at least one first connector mounted on the motherboard and to the test bus;
a control matrix, the control matrix being electrically connected to the at least one first connector of the motherboard and therethrough being electrically connectable to the at least one TAM module, the control matrix providing a matrix output signal to the at least one TAM module for selectively placing the electrical circuit of the at least one TAM module in a normal operating mode and at least one test mode; and
a controller, the controller being responsive to an input control signal and generating a controller output signal provided to the control matrix, the control matrix providing the matrix output signal to the at least one TAM module in response to the controller output signal received thereby.

2. A Test Access Matrix (TAM) system as defined by claim 1, wherein the electrical circuit of the at least one TAM module includes at least one switching element, the at least one switching element being switchable between a first state corresponding to the normal operating mode of the at least one TAM module and a second state corresponding to the at least one test mode of the at least one TAM module in response to the matrix output signal.

3. A Test Access Matrix (TAM) system as defined by claim 2, wherein the at least one switching element is a relay.

4. A Test Access Matrix (TAM) system as defined by claim 2, wherein the at least one TAM module further includes a protector circuit electrically coupled to the electrical circuit thereof.

5. A Test Access Matrix (TAM) system as defined by claim 1, wherein the connector block includes at least one side having a plurality of upstanding pin contacts extending therefrom; wherein the motherboard is in the form of a printed circuit board having a plurality of pass-through holes formed through the thickness thereof, the motherboard being mountable on the connector block on the at least one side thereof, the plurality of upstanding pin contacts being received by the plurality of pass-through holes and extending through the motherboard; and wherein the at least one TAM module is electrically engageable with a portion of at least one upstanding pin contact of the plurality of pin contacts extending through the motherboard.

6. A Test Access Matrix (TAM) system as defined by claim 1, wherein the connector block includes at least one side having formed therein a plurality of sockets; wherein the motherboard is in the form of a printed circuit board having a plurality of pass-through holes formed through the thickness thereof, the motherboard being mountable on the connector block with respective pass-through holes of the plurality of pass-through holes being in alignment with corresponding sockets of the plurality of sockets of the connector block; and wherein the at least one TAM module includes at least one pin contact, the at least one pin contact being receivable by one pass-through hole of the plurality of pass-through holes of the motherboard and extending therethrough and being receivable by one socket of the plurality of sockets of the connector block.

7. A Test Access Matrix (TAM) protector module mountable on a connector block of a telecommunications system for protecting and testing telecommunications lines connected to the connector block, the TAM protector module being in electrical communication with at least a pair of telecommunications equipment lines and a pair of telecommunications distribution lines and a test bus, the TAM protector module comprising:
a test circuit selectively in electrical communication with at least one of the pair of telecommunications equipment lines and the pair of telecommunications distribution lines; and
a protector circuit, the protector circuit being in electrical communication with at least the pair of telecommunications distribution lines.

8. A Test Access Matrix (TAM) protector module as defined by claim 7, wherein the test circuit of the TAM module includes at least one switching element, the at least one switching element being switchable between a first state wherein at least one of the pair of telecommunications equipment lines and the pair of telecommunications distribution lines is in electrical communication with the test bus, and a second state wherein the pair of telecommunications equipment lines and the pair of telecommunications distribution lines are not in electrical communication with the test bus.

9. A Test Access Matrix (TAM) protector module as defined by claim 8, wherein the at least one switching element is a relay.

10. A Test Access Matrix (TAM) protector module as defined by claim 7, wherein the test circuit is a switching circuit, the switching circuit being switchable between a first state wherein the pair of telecommunications equipment lines is in electrical communication with the test bus, a second state wherein the pair of telecommunications distribution lines is in electrical communication with the test bus, a third state wherein each of the pair of telecommunications equipment lines and the pair of telecommunications distribution lines is in electrical communication with the test bus, and a fourth state wherein the pair of telecommunications equipment lines and the pair of telecommunications distribution lines are not in electrical communication with the test bus.

11. A Test Access Matrix (TAM) system as defined by claim 1, wherein the control matrix includes a plurality of switching elements, each switching element of the plurality of switching elements being switchable between a first conductive state and a second non-conductive state, the first conductive state and the second non-conductive state of selected switching elements of the control matrix determining the matrix output signal provided to the at least one TAM module.

12. A Test Access Matrix (TAM) system operable with a connector block of a telecommunications system for testing telecommunications lines connected to the connector block, which comprises:
a motherboard mountable on the connector block, the motherboard having a plurality of first connectors mounted thereon and a test bus electrically connected to the plurality of first connectors;
a plurality of TAM modules, each TAM module having an electrical test circuit and a protector circuit, each TAM module of the plurality of TAM modules having a second connector mounted thereon which is electrically connectable to a respective first connector of the plurality of first connectors mounted on the motherboard and thereby connectable to the test bus;
a control matrix, the control matrix being electrically connected to the plurality of first connectors of the motherboard and therethrough being electrically connectable to the plurality of TAM modules, the control matrix providing a matrix output signal to the plurality of TAM modules for selectively placing the electrical test circuit of the plurality of TAM modules in a normal operating mode and at least one test mode; and
a controller, the controller being responsive to an input control signal and generating a controller output signal provided to the control matrix, the control matrix providing the matrix output signal to a respective TAM module of the plurality of TAM modules in response to the controller output signal received thereby.
